(19) United States
(12) Patent Application Publication
(10) Pub. No.: US 2016/0238777 A1
(43) Pub. Date: Aug. 18, 2016

(54) LIGHT GUIDE PLATE ,LIGHT SOURCE MODULE AND DISPLAY DEVICE

(71) Applicant: Radiant Opto-Electronics Corporation, Kaohsiung (TW)

(72) Inventors: Hsueh-Ju CHEN, KAOHSIUNG (TW); Ya-Yun HSIEH, KAOHSIUNG CITY (TW); Pei-Fen HOU, KAOHSIUNG CITY (TW); Shin-Bo LIN, KAOHSIUNG (TW); Chia-Yin CHANG, KAOHSIUNG (TW)

(21) Appl. No.: 15/139,317

(22) Filed: Apr. 26, 2016

Related U.S. Application Data
(63) Continuation-in-part of application No. 14/497,341, filed on Sep. 26, 2014.

(30) Foreign Application Priority Data
May 27, 2014 (TW) 103118457
May 26, 2015 (TW) 104116843

(51) Int. Cl. F21V 8/00

(52) U.S. Cl. CPC G02B 6/0036; G02B 6/0068; G02B 6/0016

(57) ABSTRACT

A light guide plate and a light source module are provided. Light guide plate includes a main body and microstructures disposed on the main body. The main body includes a light-incident surface and a light-emitting surface. Each of the microstructures includes a first optical surface, a second optical surface, a third optical surface and a fourth optical surface. The first optical surface and the second optical surface are inclined in relation to the light-incident surface. A first angle is included between the first optical surface and the light-emitting surface. A second angle is included between the second optical surface and the light-emitting surface. The third optical surface and the fourth optical surface connect the first optical surface and the second optical surface. A third angle is included between the third optical surface and the light-emitting surface. A fourth angle is included between the fourth optical surface and the light-emitting surface.

### RELATED APPLICATIONS

This application is a continuation-in-part application of U.S. application Ser. No. 14/497,341, filed on Sep. 26, 2014, which claims priority to Taiwan Application Serial Number 103118457, filed May 27, 2014. This application also claims priority to Taiwan Application Serial Number 104116843, filed May 26, 2015. The entire disclosures of all the above applications are hereby incorporated by reference herein.

### BACKGROUND

1. Field of Invention

The present invention relates to a light guide element. More particularly, the present invention relates to a light guide plate, light source module and display device.

2. Description of Related Art

A conventional light guide plate used in a backlight module has a light-incident surface, a light-emitting surface and a reflecting surface. Light generated by a light source enters the light guide plate from the light-incident surface and is emitted out from the light-emitting surface of the light guide plate. Another conventional light guide plate used in a lamp has two opposite light-emitting surfaces. After entering the light guide plate, light generated by the light source is emitted out from the respective light-emitting surfaces. In order to mix the light passing through the light guide plate uniformly, lateral V-shaped structures are generally disposed on the light-emitting surfaces of the light guide plate.

However, such lateral V-shaped structures cause the light guide plate to have high light concentration and directivity, such that obvious dark/bright bands or hot spots are generated on the light-emitting surface of the light guide plate, thus affecting the optical appearance of the light guide plate.

### SUMMARY

One object of the present invention is to provide a light guide plate and a light source module, in which light-emitting angle and directivity of light emitted from a light guide plate can be changed by varying shapes, angles, heights, depths or arrangements of microstructures disposed on a light-emitting surface of the light guide plate, so as to increase light-emitting efficiency and uniformity of the overall light-emitting appearance of the light guide plate.

Another object of the present invention is to provide a light guide plate and a light source module, in which light-mixing structures are disposed near a light-incident surface of the light guide plate to be collocated with and the microstructures, so that the problems of non-uniform appearance causing by the dark/bright bands near the light-incident surface of the conventional light guide plate can be improved, thus increasing optical effect of the light guide plate.

According to the aforementioned objects, a light guide plate is provided. The light guide plate includes a main body and plural microstructures. The main body includes a light-incident surface and a light-emitting surface connected to the light-incident surface. The microstructures are disposed on the light-emitting surface. Each of the microstructures includes a first optical surface, a second optical surface, a third optical surface and a fourth optical surface. The first optical surface is inclined in relation to the light-incident surface and is connected to the light-emitting surface, in which a first angle is included between the first optical surface and the light-emitting surface. The second optical surface is inclined in relation to the light-incident surface and is connected to the light-emitting surface, in which a second angle is included between the second optical surface and the light-emitting surface. The third optical surface connects the light-emitting surface, the first optical surface and the second optical surface, in which a third angle is included between the third optical surface and the light-emitting surface. The fourth optical surface is opposite to the third optical surface and connects the light-emitting surface, the first optical surface and the second optical surface, in which a fourth angle is included between the fourth optical surface and the light-emitting surface.

According to an embodiment of the present invention, the first optical surface and the second optical surface of each of the microstructures are connected to form a ridge line substantially parallel to an edge of the light-incident surface.

According to an embodiment of the present invention, each of the microstructures further includes a top surface connecting the first optical surface, the second optical surface, the third optical surface and the fourth optical surface, and an edge of the top surface connected to the first optical surface or the second optical surface is substantially parallel to an edge of the light-incident surface.

According to an embodiment of the present invention, each of the top surfaces is a flat surface or an arc surface.

According to an embodiment of the present invention, each of the third optical surfaces has one or more flat, angled, faceted or curved reflective or refractive surfaces to change a light output ray angle distribution to a greater extent.

According to an embodiment of the present invention, each of the fourth optical surfaces one or more flat, angled, faceted or curved reflective or refractive surfaces to change a light output ray angle distribution to a greater extent.

According to an embodiment of the present invention, each of the microstructures is a convex portion or a concave portion.

According to an embodiment of the present invention, the light guide plate further includes plural light-mixing structures disposed on the light-emitting surface adjacent to the light-incident surface.

According to an embodiment of the present invention, the light-mixing structures are dotted structures.

According to an embodiment of the present invention, the light-mixing structures are striped structures, and the light-mixing structures extend along a direction from one side of the light-emitting surface near the light-incident surface to the other side of the light-emitting surface away from the light-incident surface.

According to an embodiment of the present invention, the light-mixing structures are striped structures, and each of the light-mixing structures has a width gradually decreasing from one end of the light-mixing structure near the light-incident surface to the other end of the light-mixing structure away from the light-incident surface.

According to an embodiment of the present invention, each of the light-mixing structures is a convex portion or a concave portion.

According to an embodiment of the present invention, each of the light-mixing structures has a length extending along a direction from one side of the light-emitting surface near the light-incident surface to the other side of the light-emitting surface away from the light-incident surface, and a ratio of the length of the light-mixing structure to an overall length of the main body is greater than or equal to 0.5% and is smaller than or equal to 10%.

According to an embodiment of the present invention, a blank portion between the light-mixing structures and the microstructures, and a ratio of a length of the blank portion to an overall length of the main body is greater than 0% and is smaller than or equal to 5%.

According to an embodiment of the present invention, the light-mixing structures are connected to the microstructures.

According to an embodiment of the present invention, the main body further comprises a surface opposite to the light-emitting surface, and plural optical microstructures are disposed on the surface.

According to an embodiment of the present invention, the optical microstructures are dotted structures, striped structures or structures similar to the microstructures.

According to an embodiment of the present invention, the third angle and the fourth angle are greater than or equal to −45 degrees and are smaller than or equal to 45 degrees.

According to an embodiment of the present invention, the smaller one of the first angle and the second angle faces towards the light-incident surface, and the greater one of the first angle and the second angle faces away from the light-incident surface.

According to the aforementioned objects, a light source module is provided. The light source module includes the aforementioned light guide plate and a light source. The light source is disposed adjacent to the light-incident surface of the light guide plate.

According to an embodiment of the present invention, the microstructures are arranged to form plural microstructure rows, and each of the microstructure rows has an arrangement density which is greater with increase of a distance between the microstructure row and the light source.

According to an embodiment of the present invention, the microstructures are arranged to form plural microstructure rows, and there is a distance between two adjacent microstructure rows, in which the distance is smaller with increase of a distance between the microstructure rows and the light source.

According to an embodiment of the present invention, the sizes of the microstructures are greater with increase of a distance between the microstructure row and the light source.

According to an embodiment of the present invention, the microstructures are arranged divergently along a light-emitting direction of the light source.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic structural diagram showing one type of light guide plate in accordance with a first embodiment of the present invention;

FIG. 2 is a schematic cross-sectional view of microstructure viewed along a line A-A in FIG. 1;

FIG. 3 is a schematic structural diagram showing one type of microstructure in accordance with the first embodiment of the present invention;

FIG. 4A is a schematic structural diagram showing another type of microstructure in accordance with the first embodiment of the present invention;

FIG. 4B is a schematic structural diagram showing another type of microstructure in accordance with the first embodiment of the present invention;

FIG. 5A is a schematic structural diagram showing one type of microstructure in accordance with a second embodiment of the present invention;

FIG. 5B is a schematic structural diagram showing another type of microstructure in accordance with the second embodiment of the present invention;

FIG. 6 is a schematic structural diagram showing one type of microstructure in accordance with a third embodiment of the present invention;

FIG. 7 is a schematic structural diagram showing one type of microstructure in accordance with a fourth embodiment of the present invention;

FIG. 8 is a schematic structural diagram showing another type of light guide plate in accordance with the first embodiment of the present invention;

FIG. 9 is a schematic structural diagram showing another type of light guide plate in accordance with a fifth embodiment of the present invention;

FIG. 10 is a schematic cross-sectional view of the microstructure viewed along a line B-B in FIG. 9;

FIG. 11 is a schematic structural diagram showing another type of light guide plate in accordance with a sixth embodiment of the present invention;

FIG. 12 is a schematic structural diagram showing another type of light guide plate in accordance with a seventh embodiment of the present invention;

FIG. 13 is a schematic top view of the light guide plate in accordance with the first embodiment of the present invention; and

FIG. 14A-FIG. 14D are schematic diagrams showing different arrangements of microstructures in accordance with an embodiment of the present invention.

FIG. 15 is a schematic structural diagram showing a light source module in accordance with an embodiment of the present invention;

FIG. 16 is a schematic side view of the light source module in accordance with an embodiment of the present invention;

FIG. 17A is a schematic diagram showing arrangement densities of first microstructures and second microstructures respectively arranged in relation to a first light source and a second light source;

FIG. 17B is a diagram showing luminance distribution on a light guide plate when one or both of a first light source and a second light source emit light; and

FIG. 18 is a schematic structural diagram showing a display device in accordance with an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

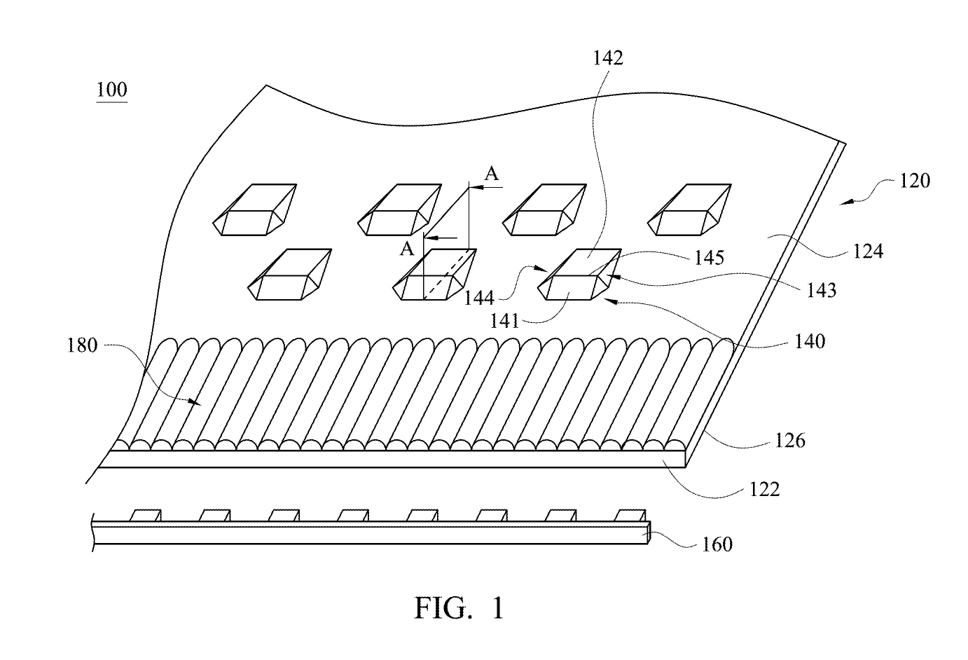

Referring to FIG. 1, FIG. 1 is a schematic structural diagram showing one type of light guide plate 100 in accordance with a first embodiment of the present invention. The light guide plate 100 is applicable to a backlight module or a lamp. The light guide plate 100 includes a main body 120 and plural microstructures 140. The microstructures 140 are disposed on the main body 120 for adjusting optical trends and increasing luminance uniformity of the light guide plate 100.

In the light guide plate 100, the main body 120 is a transparent plate or another equivalent transparent element. The main body 120 mainly includes a light-incident surface 122 and a light-emitting surface 124. The light-emitting surface 124 is connected to the light-incident surface 122. A light source 160 can be disposed adjacent to the light-incident surface 122 and light generated by the light source 160 will enter the light guide plate 100 from the light-incident surface 122.

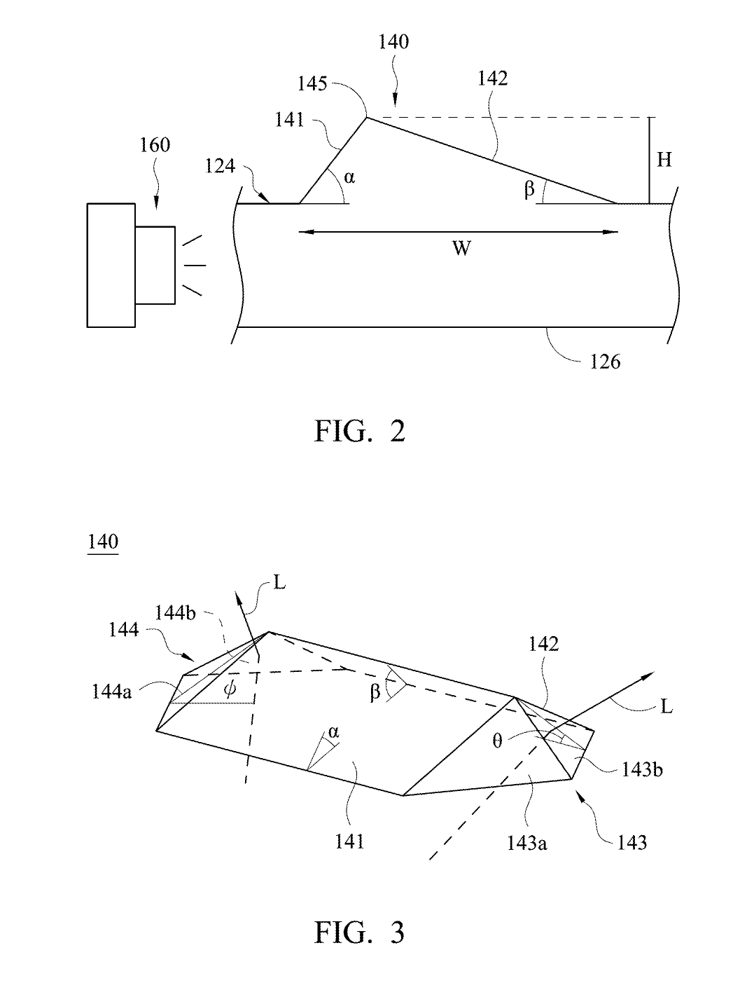

Referring to FIG. 1 and FIG. 2, FIG. 2 is a schematic cross-sectional view of the microstructure 140 viewed along a line A-A in FIG. 1. In the present embodiment, the microstructures 140 are disposed on the light-emitting surface 124, and the microstructures 140 are convex portions protruding from the light-emitting surface 124. Moreover, each of the microstructures 140 includes a first optical surface 141, a second optical surface 142, a first side optical surface 143 and a second side optical surface 144. The first optical surface 141 is connected to the light-emitting surface 124 and inclined in relation to the light-incident surface 122. A first angle α is included between the first optical surface 141 and the light-emitting surface 124. Similarly, the second optical surface 142 is connected to the light-emitting surface 124 and inclined in relation to the light-incident surface 122. A second angle β is included between the second optical surface 142 and the light-emitting surface 124. Moreover, the first optical surface 141 and the second optical surface 142 of each of the microstructures 140 are connected to form a ridge line 145 which is substantially parallel to an edge of the light-incident surface 122. In addition, the first angle α and the second angle β are designed corresponding to different optical films collocated with the light guide plate 100. Meanwhile, the first optical surface 141 and the second optical surface 142 are inclined in relation to the light-incident surface 122, so that light-emitting angle and light directivity of light emitted from the light guide plate 100 can be changed, thereby increasing light-emitting efficiency and uniformity of the overall light-emitting appearance of the light guide plate 100. In addition, a shape of each of the microstructures 140 can be varied with a width W, the first angle α and the second angle β thereof, and a height H between a top end of each of the microstructures 140 to the light-emitting surface 124 can be changed by adjusting the first angle α and a top end the second angle β.

Referring to FIG. 1 and FIG. 2, in some embodiments, the light guide plate 100 includes a surface 126 opposite to the light-emitting surface 124. The surface 126 can be a reflecting surface or a light-emitting surface. When the light guide plate 100 is applied to a backlight module, the surface 126 is a reflecting surface. When the light guide plate 100 is applied to a lamp, the surface 126 is a light-emitting surface.

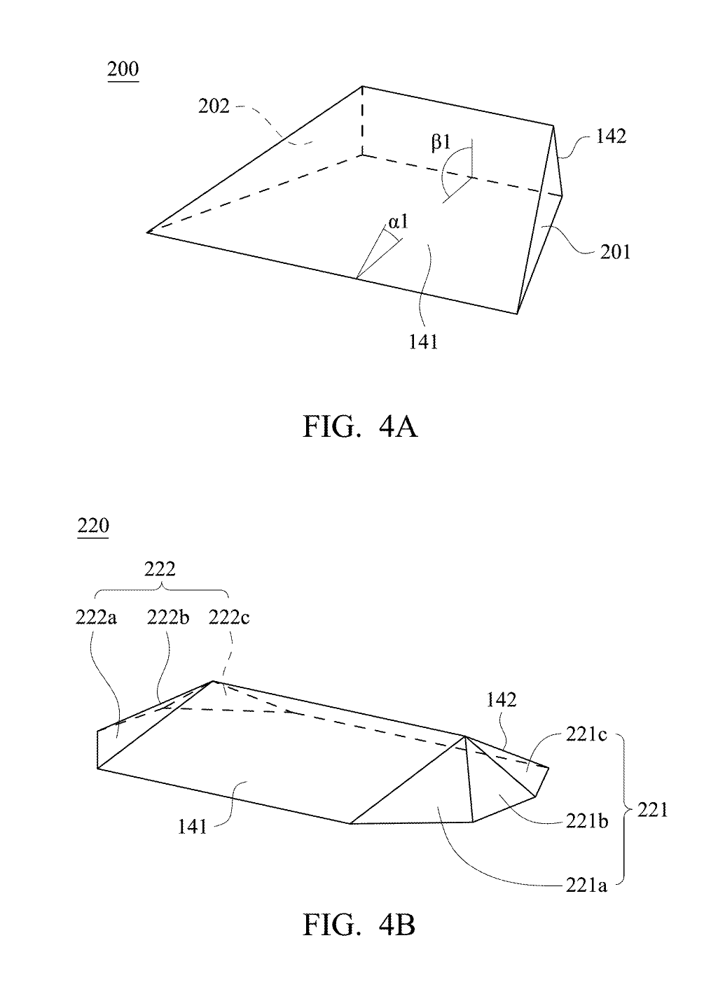

Referring to FIG. 1 and FIG. 3, FIG. 3 is a schematic structural diagram showing one type of microstructure 140 in accordance with the first embodiment of the present invention. The first side optical surface 143 mainly connects the light-emitting surface 124, the first optical surface 141 and the second optical surface 142. Moreover, a first side angle θ is included between the first side optical surface 143 and the light-emitting surface 124. The second side optical surface 144 is opposite to the first side optical surface 143. Moreover, the second side optical surface 144 connects the light-emitting surface 124, the first optical surface 141 and the second optical surface 142. A second side angle φ is included between the second side optical surface 144 and the light-emitting surface 124. In some embodiments, each of the first side optical surfaces 143 and the second side optical surfaces 144 has one or more flat, angled, faceted or curved reflective or refractive surfaces. As shown in FIG. 3, in the present embodiment, the first side optical surface 143 includes optical units 143a and 143b, and the second side optical surface 144 includes optical units 144a and 144b. The first side optical surface 143 and the second side optical surface 144 are used to change a light output ray angle distribution of the light beam L to a greater extent after the light beam L emitting from the microstructures 140. Therefore, the light concentration degree of the microstructures 140 can be changed by adjusting the first side angle θ and the second side angle φ. In some embodiments, the first side angle θ and the second side angle φ are in a range from −45 degrees to 45 degrees.

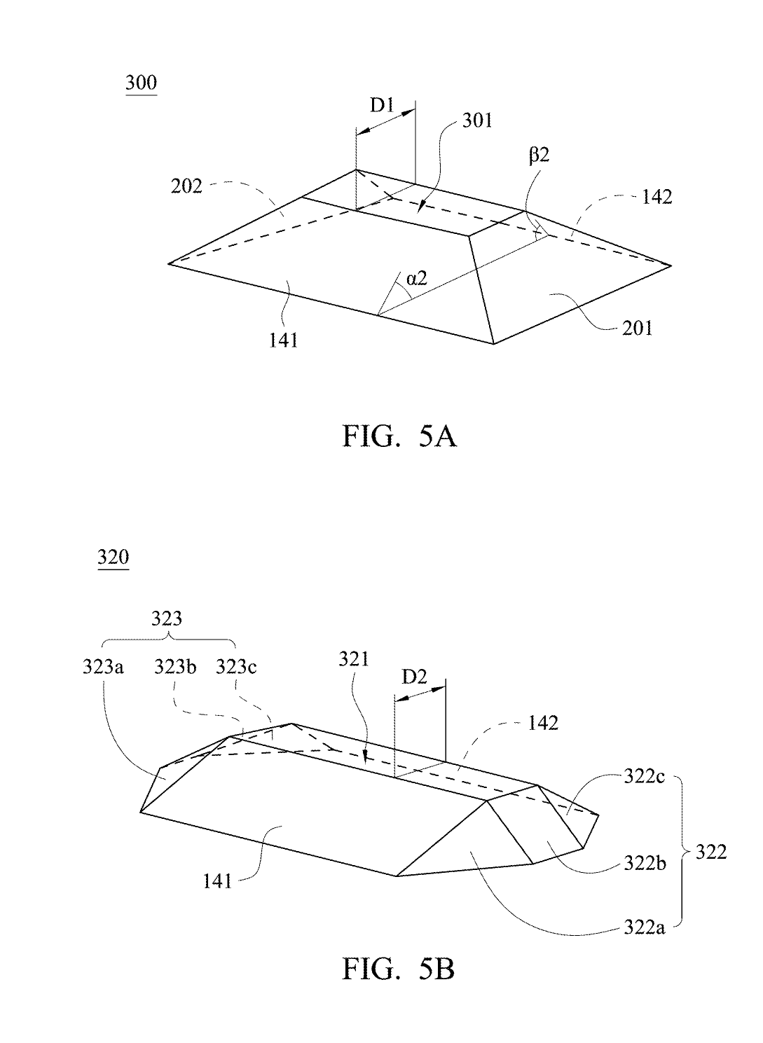

In the embodiment of FIG. 3, the first side optical surface 143 and the second side optical surface 144 of the microstructures 140 are respectively composed of two optical units. In some embodiments, the microstructures 140 have different designs. Referring to FIG. 4A, FIG. 4A is a schematic structural diagram showing another type of microstructure in accordance with the first embodiment of the present invention. As shown in FIG. 4A, a microstructure 200 is similar to the aforementioned microstructure 140, and the main difference therebetween is that each of a first side optical surface 201 and a second side optical surface 202 of the microstructure 200 is one single surface. Moreover, a first angle α1 between the first optical surface 141 and a light-emitting surface and a second angle β1 between the second optical surface 142 and the light-emitting surface of the microstructure 200 are different from the first angle α and the second angle β of the microstructure 140.

Simultaneously referring to FIG. 4B, FIG. 4B is a schematic structural diagram showing another type of microstructure in accordance with the first embodiment of the present invention. As shown in FIG. 4B, a microstructure 220 is similar to the aforementioned microstructure 140, and the main difference therebetween is that a first side optical surface 221 of the microstructure 220 is composed of optical units 221a, 221b and 221c, and a second side optical surface 222 is composed of optical units 222a, 222b and 222c. It is noted that all of the first side optical surfaces 143, 201 and 221 or the second side optical surface 144, 202 and 222 composed of two surfaces, one single surface or three surfaces can function to change the light output ray angle distribution of the light beam L to a greater extent.

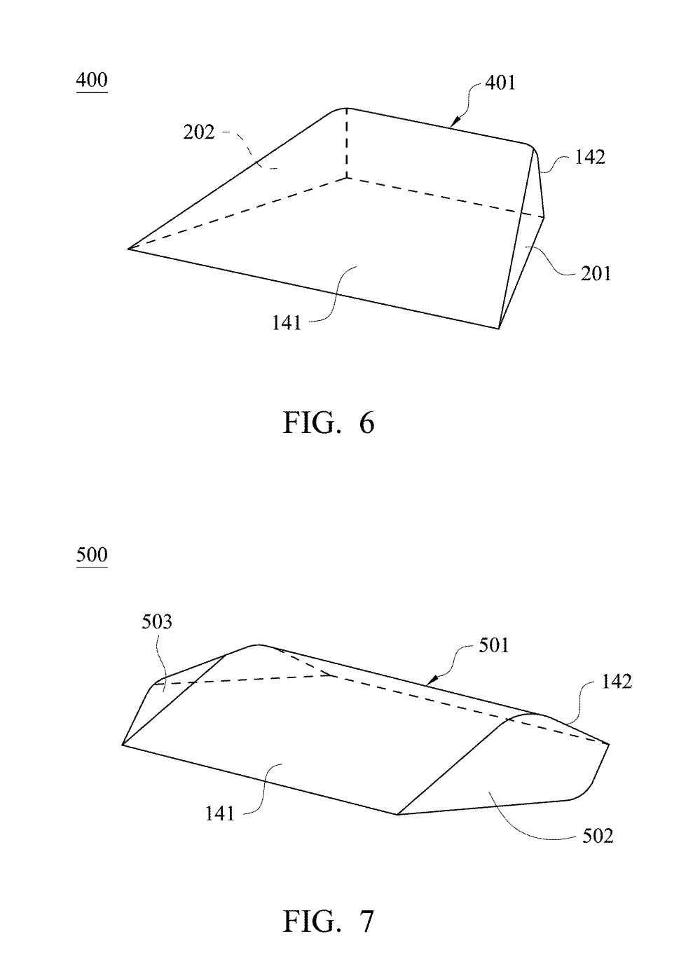

In the present invention, the microstructures 140, 200 and 220 are pyramid structures. In some embodiments, the microstructure 200 has different designs. Referring to FIG. 5A, FIG. 5A is a schematic structural diagram showing one type of microstructure in accordance with a second embodiment of the present invention. As shown in FIG. 5A, a microstructure 300 is similar to the aforementioned microstructure 200, and the main difference therebetween is that the microstructure 300 includes a top surface 301. The top surface 301 connects the first optical surface 141, the second optical surface 142, the first side optical surface 201 and the second side optical surface 202. In other words, the microstructure 300 is a frustum. In the present embodiment, an edge of the top surface 301 connected to the first optical surface 141 or the second optical surface 142 is substantially parallel to an edge of the light-incident surface of the light guide plate. Moreover, a first angle α2 is included between the first optical surface 141 and the light-emitting surface, and a second angle β2 is included between the second optical surface 142 and the light-emitting surface of the microstructure 300, in which the first angle α2 and the second angle β2 are different from the first angle α1 and the second angle β1 of microstructure 200.

Referring to FIG. 5B, FIG. 5B is a schematic structural diagram showing another type of microstructure in accordance with the second embodiment of the present invention. As shown in FIG. 5B, a microstructure 320 is similar to the aforementioned microstructure 300, and the microstructure 320 is a frustum and has a top surface 321. The main difference between the microstructure 320 and the microstructure 300 is that a first side optical surface 322 of the microstructure 320 is composed of three optical units 322a, 322b and 322c, and a second side optical surface 323 is composed of three optical units 323a, 323b and 323c. In addition, as shown in FIG. 5A and FIG. 5B, in some embodiments, the top surfaces 301 and 321 are flat surfaces, and respectively have a width D1 and a width D2. The width D1 and the width D2 can be designed corresponding to different optical requirements. Similarly, in the present embodiment, an edge of the top surface 321 connected to the first optical surface 141 or the second optical surface 142 is substantially parallel to an edge of the light-incident surface of the light guide plate.

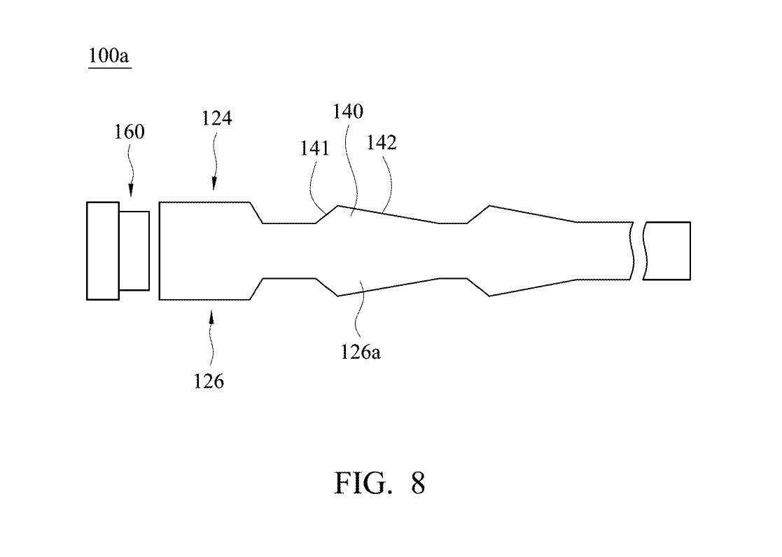

In other embodiments, the microstructure 140 shown in FIG. 4A has different designs. Referring to FIG. 6, FIG. 6 is a schematic structural diagram showing one type of microstructure in accordance with a third embodiment of the present invention. As shown in FIG. 4A, a microstructure 400 is similar to the aforementioned microstructure 200, and the main difference therebetween is that each of the microstructures 400 includes a top surface 401, and the top surface 401 is an arc surface. In the present embodiment, a radian of the top surface 401 can be designed corresponding to different optical requirements.

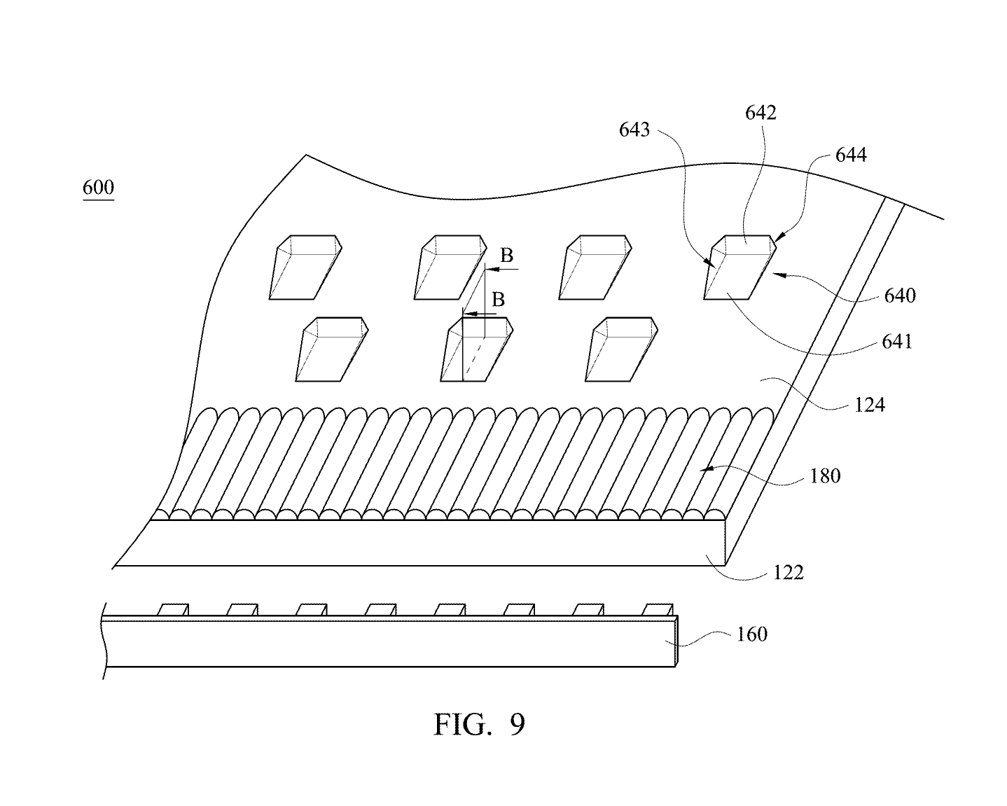

In other embodiments, the microstructure 300 shown in FIG. 5A has different designs. Referring to FIG. 7, FIG. 7 is a schematic structural diagram showing one type of microstructure in accordance with a fourth embodiment of the present invention. In the present embodiment, a microstructure 500 is similar to the aforementioned microstructure 300, and the main difference therebetween is that the microstructure 500 includes a top surface 501, and each of the top surface 501, a first side optical surface 502 and a second side optical surface 503 of the microstructure 500 is one single arc surface. In addition, radians of the top surface 501, the first side optical surface 502 and the second side optical surface 503 can be designed corresponding to different optical requirements.

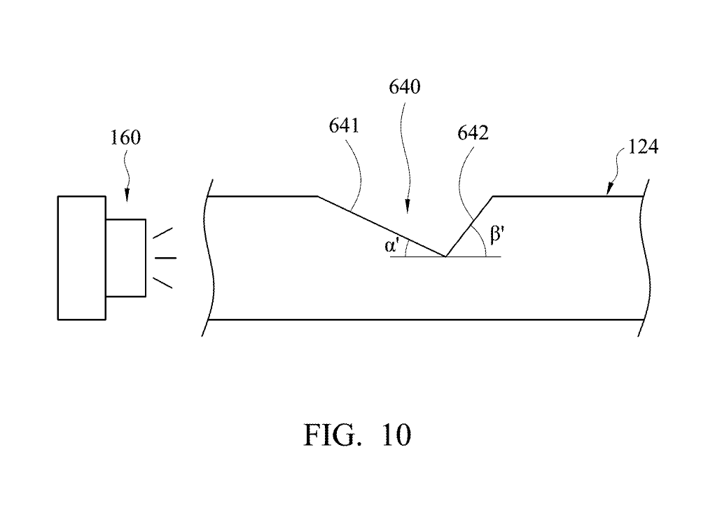

In other embodiments, the light guide plate 100 shown in FIG. 1 has different designs. Referring to FIG. 8, FIG. 8 is a schematic structural diagram showing another type of light guide plate in accordance with the first embodiment of the present invention. As shown in FIG. 8, a light guide plate 100a is similar to the aforementioned light guide plate 100, and the main difference therebetween is that the surface 126 of the light guide plate 100a is implemented with plural optical microstructures 126a. Moreover, the optical microstructures 126a are dotted structures, striped structures or structures similar to the microstructures 140, so as to meet different optical requirements. In the present embodiment, the surface 126 is a light-emitting surface, and the optical microstructures 126a on the surface 126 are similar to the microstructures 140.

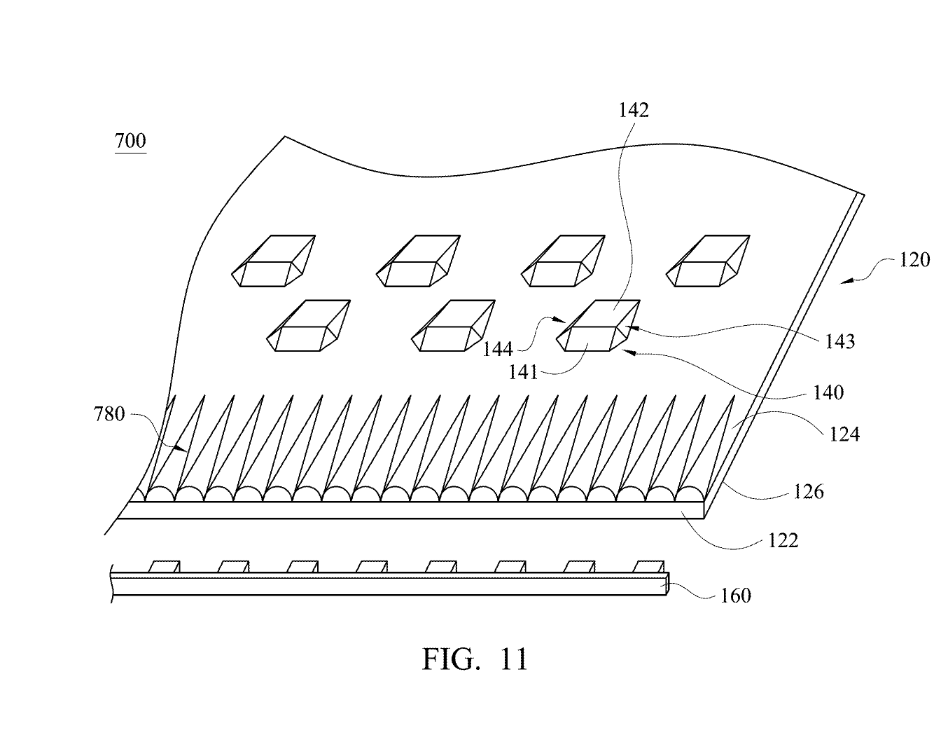

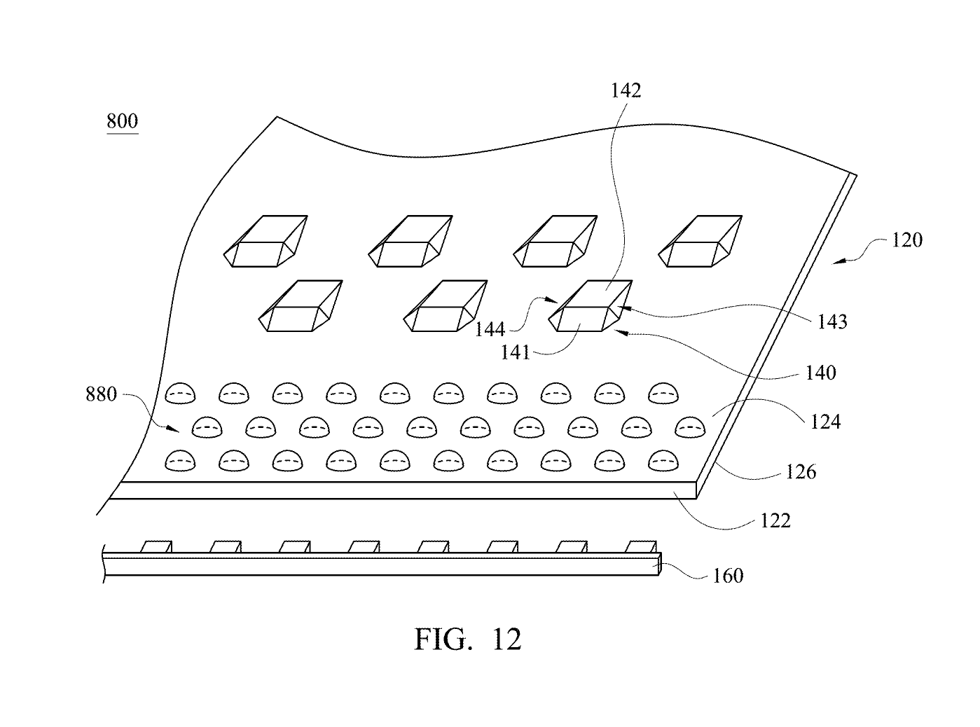

In some embodiments, the light guide plate 100 has different designs. Referring to FIG. 9 and FIG. 10, FIG. 9 is a schematic structural diagram showing another type of light guide plate in accordance with a fifth embodiment of the present invention, and FIG. 10 is a schematic cross-sectional view of microstructure 640 viewed along a line B-B in FIG. 9. As shown in FIG. 9, a light guide plate 600 is similar to the aforementioned light guide plate 100, and the main difference therebetween is that microstructures 640 of the light guide plate 600 are concave portions recessed into the light-emitting surface 124 of the light guide plate 600. Similarly, each of the microstructures 640 includes a first optical surface 641, a second optical surface 642, a first side optical surface 643 and a four optical surface 644. Moreover, the light-emitting angle and light directivity of light emitted from the light guide plate 600 can be changed by adjusting inclined angles of the first optical surface 641 and the second optical surface 642 in relation to the light-incident surface 122. Meanwhile, the light-diffusing angles of light entering the microstructures 640 can be adjusted by changing the included angles between the first side optical surface 643 and the light-emitting surface or the four optical surface 644 and the light-emitting surface.

Simultaneously referring to FIG. 1 and FIG. 2, because the microstructures 140 shown in FIG. 1 are convex portions, most of the light entering the light guide plate 100 from the light-incident surface 122 is emitted towards the second optical surface 142. In other words, the second optical surface 142 is a surface which receives light directly. Therefore, in some embodiments, for achieving the purpose of guiding light the area of the second optical surface 142 is greater than that of the first optical surface 141. In other words, the smaller one of the first angle α and the second angle β faces towards the light-incident surface 122, and the greater one of the first angle α and the second angle β faces away from the light-incident surface 122. On the other hand, because the microstructures 640 shown in FIG. 9 and FIG. 10 are concave portions, most of the light entering the light guide plate 100 from the light-incident surface 122 is emitted towards the first optical surface 641. In other words, the first optical surface 641 is a surface which receives light directly. Therefore, in the structural design, the area of the first optical surface 641 is greater than that of the second optical surface 642, so as to increase the light-emitting efficiency and the uniformity of the overall light-emitting appearance of the light guide plate 600.

Referring to FIG. 1 and FIG. 9, in some embodiments, each of the light guide plates 100 and 600 includes plural light-mixing structures 180. The light-mixing structures 180 are disposed on the light-emitting surface 124 adjacent to the light-incident surface 122. Therefore, after being emitted from the light source 160 and entering the light guide plate 100, the light will pass through the light-mixing structures 180, such that the problems of non-uniform light appearance causing by the bright bands appearing on the light-incident surface of the conventional light guide plate can be improved. In addition, in the embodiment of FIG. 1 and FIG. 9, the light-mixing structures 180 are striped structures, and the striped structures are convex portions protruding from the light-emitting surface 124 or concave portions recessed into the light-emitting surface 124. Moreover, the light-mixing structures 180 extend along a direction from one side of the light-emitting surface 124 near the light-incident surface 122 to the other side of the light-emitting surface 124 away from the light-incident surface 122.

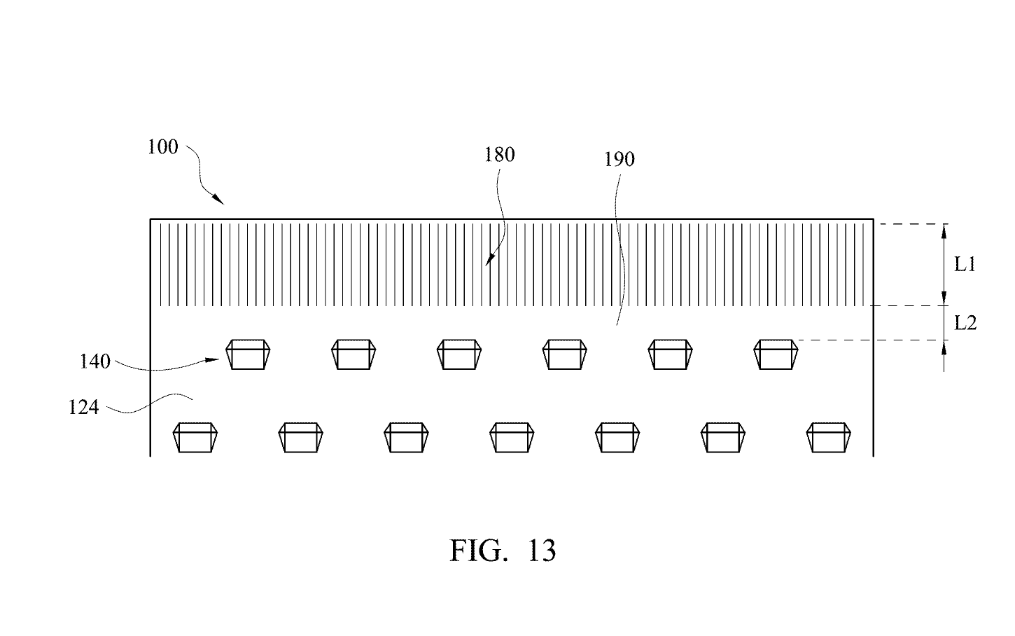

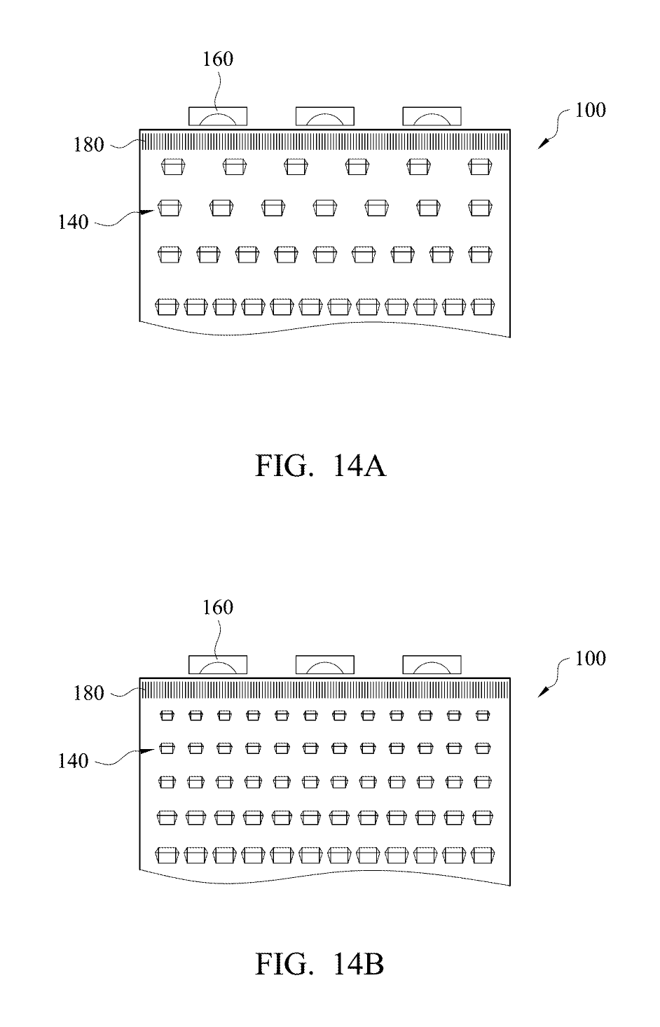

Referring to FIG. 11, FIG. 11 is a schematic structural diagram showing another type of light guide plate in accordance with a sixth embodiment of the present invention. As shown in FIG. 11, a light guide plate 700 is similar to the aforementioned light guide plate 100, and the main difference therebetween is that light-mixing structures 780 of the light guide plate 700 have different shapes. In the present embodiment, each of the light-mixing structures 780 has a width gradually decreasing from one end of the light-mixing structure 780 near the light-incident surface 122 to the other end of the light-mixing structure 780 away from the light-incident surface 122. In other embodiments, a depth or a height of each of the light-mixing structures 780 can be designed to meet different requirements. For example, the depth or the height of each of the light-mixing structures 780 is gradually decreasing from one end of the light-mixing structure 780 near the light-incident surface 122 to the other end of the light-mixing structure 780 away from the light-incident surface 122. In other embodiments, as shown in FIG. 12, FIG. 12 is a schematic structural diagram showing another type of light guide plate 800 in accordance with a seventh embodiment of the present invention. In the shown embodiment of FIG. 12, light-mixing structures 880 of the light guide plate 800 are dotted structures.

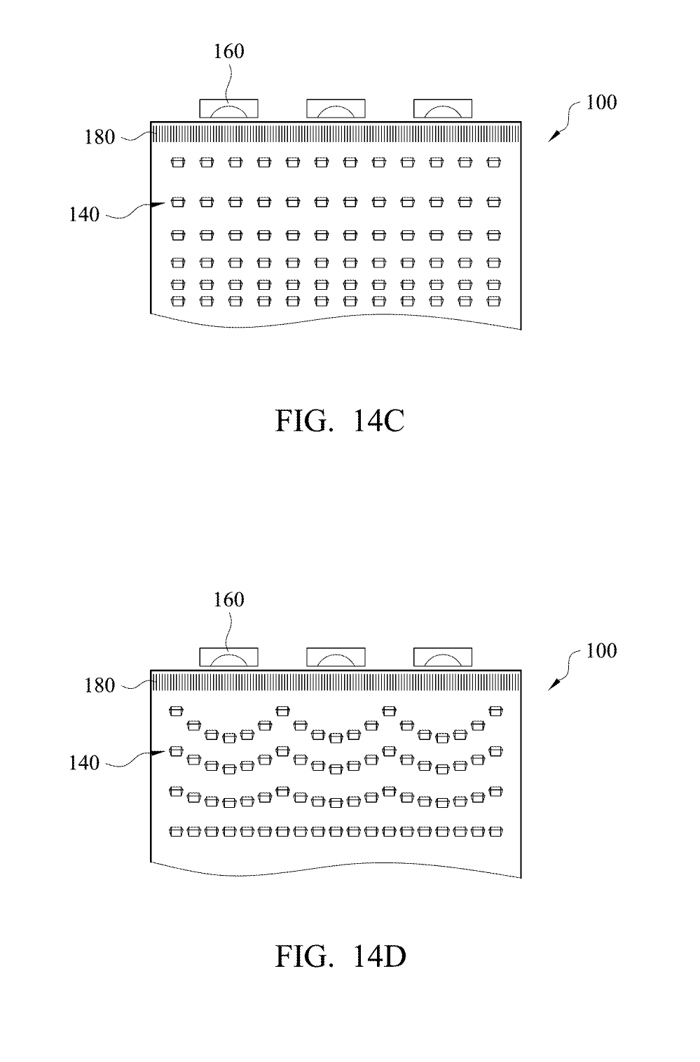

Simultaneously referring to FIG. 1 and FIG. 13, FIG. 13 is a schematic top view of the light guide plate 100 in accordance with the first embodiment of the present invention. In the present embodiment, each of the light-mixing structures 180 has a length L1, and a ratio of the length L1 of the light-mixing structure 180 to an overall length of the main body 120 is in a range from 0.5% to 10%. In other embodiments, there is a blank portion 190 between the light-mixing structures 180 and the microstructures 140, and a ratio of a length L2 of the blank portion 190 to an overall length of the main body 120 is in a range from 0% to 5%. In other words, the microstructures 140 nearest light-mixing structures 180 can be connected to the light-mixing structures 180 directly, or not directly connected to the light-mixing structures 180 by spaced at a distance from the light-mixing structures 180. In addition, the length L1 of the light-mixing structures 180 and the length L2 of the blank portion 190 can be designed to meet different requirements, thereby generating different light-mixing effects and increase luminance uniformity of the light guide plate 100.

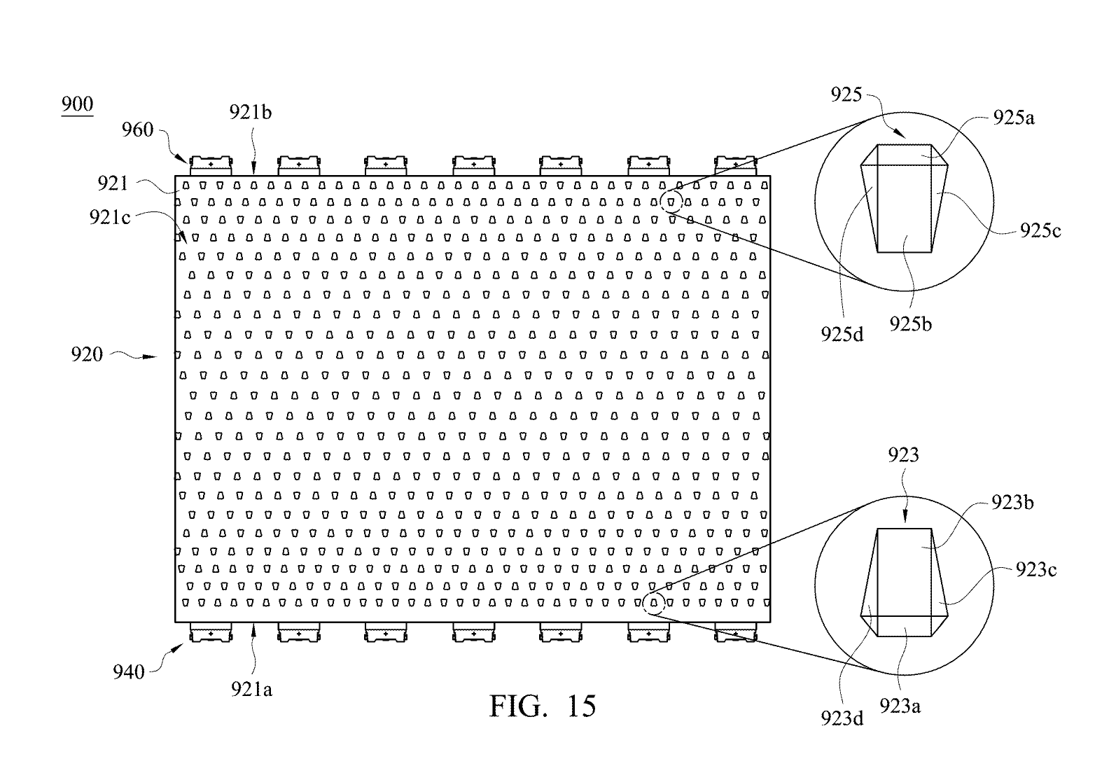

It is noted that, when the light guide plate 100 is applied to a light source module (such as a backlight module), the numbers, sizes and arrangements of the microstructures 140 can be varied corresponding to the distance between the microstructures 140 and the light source 160 or other optical requirements. Referring to FIG. 14A-FIG. 14D, FIG. 14A-FIG. 14D are schematic diagrams showing different arrangements of the microstructures 140 in accordance with an embodiment of the present invention. In the example shown in FIG. 14A, the microstructures 140 of the light guide plate 100 have the same size and are arranged to form plural microstructure rows. Each of the microstructure rows is substantially parallel to an edge of the light-incident surface of the light guide plate. Moreover, the microstructure rows near the light source 160 are sparsely arranged, and the microstructure rows away from light source 160 are densely arranged. In other words, the arrangement density of each microstructure row is greater with increase of the distance between the microstructure row and the light source 160. In addition, in the example shown in FIG. 14A, every two adjacent microstructure rows are spaced equidistantly.

In an example shown in FIG. 14B, the size of the microstructures 140 in the microstructure rows positioned near the light sources 160 is smaller, and the size of the microstructures 140 in the microstructure rows positioned away from the light sources 160 is greater. In an example shown in FIG. 14C, each of the microstructures 140 has the same size, and the distance between every two adjacent microstructure rows is smaller with increase of the distance between the microstructure rows and the light source 160. In an example shown in FIG. 14D, each of the microstructures 140 has the same size, and the microstructures near the light source 160 are arranged divergently along the light-emitting direction of the light source 160. Therefore, different arrangements of the microstructures 140 can make the light guide plate 100 emit more uniform light.

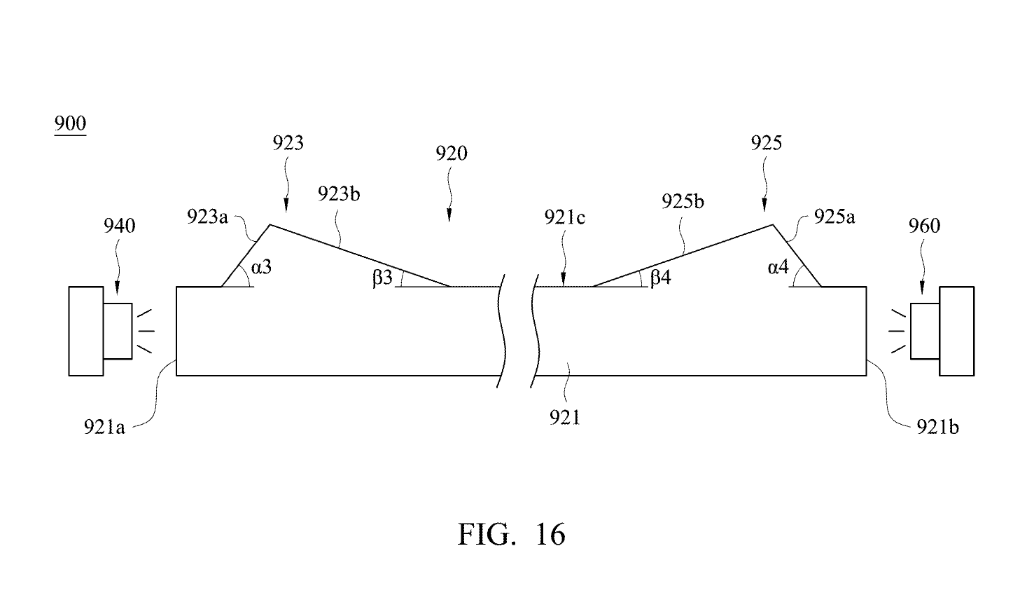

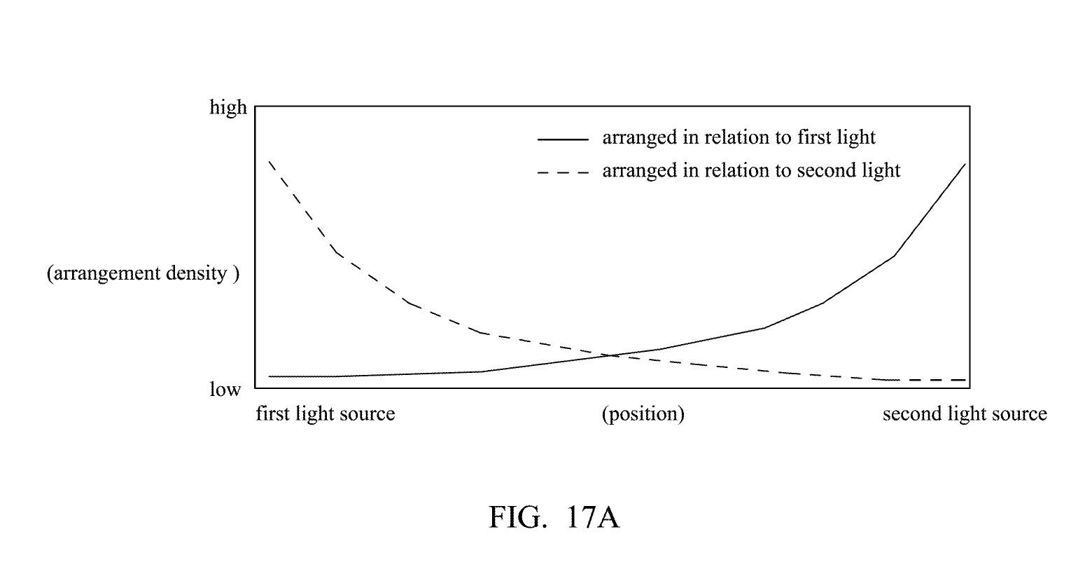

The light guide plate also can be applied to a light source module with two light sources. Referring to FIG. 15 and FIG. 16, FIG. 15 and FIG. 16 are a schematic structural diagram and a schematic side view showing a light source module 900 in accordance with an embodiment of the present invention. The light source module 900 of the present embodiment mainly includes a light guide plate 920, a first light source 940 and a second light source 960. The light guide plate includes a main body 921, plural first microstructures 923 and plural second microstructures 925. The main body 921 has a first light-incident surface 921a, a second light-incident surface 921b and a light-emitting surface 921c. The first light source 940 and the second light source 960 are respectively disposed adjacent to the first light-incident surface 921a and the second light-incident surface 921b. Moreover, the first microstructures 923 and the second microstructures 925 are simultaneously disposed on the light-emitting surface 921c of the main body 921. In the present embodiment, a length, a width and a height of each of the first microstructures 923 and the second structures 925 are smaller than that of the main body 120.

Referring to FIG. 15 and FIG. 16 again, structures of the first microstructures 923 and the second structures 925 are similar to that of the aforementioned microstructures 140. As shown in FIG. 15, each of the first microstructures 923 includes a first optical surface 923a, a second optical surface 923b, a first side optical surface 923c and a second side optical surface 923d. The first optical surface 923a is inclined in relation to the first light-incident surface 921a to form a first angle α3. It is noted that, the first optical surface 923a extends from a bottom portion to a top portion of the first microstructure 923, and the first angle α3 is an included angle between the first optical surface 923a and a level surface passing through a bottom portion of the first optical surface 923a, in which the level surface and the light-emitting surface 921c are on a same plane. The second optical surface 923b is inclined in relation to the first light-incident surface 921a to form a second angle β3. It is noted that, the second optical surface 923b extends from the bottom portion to the top portion of the first microstructure 923, and the second angle β3 is an included angle between the second optical surface 923b and a level surface passing through a bottom portion of the second optical surface 923b, in which the level surface and the light-emitting surface 921c are on a same plane. In the present embodiment, the smaller one of the first angle α3 and the second angle β3 faces towards the first light-incident surface 921a, and the greater one of the first angle α3 and the second angle β3 faces away from the first light-incident surface 921a. In the present embodiment, the second angle β3 is smaller than the first angle α3.

Similarly, each of the second microstructures 925 includes a third optical surface 925a, a fourth optical surface 925b, a third side optical surface 925c and a fourth side optical surface 925d. The third optical surface 925a is inclined in relation to the second light-incident surface 921b to form a third angle α4. It is noted that, the third optical surface 925a extends from a bottom portion to a top portion of the second microstructure 925, and the third angle α 4 is an included angle between the third optical surface 925a and a level surface passing through a bottom portion of the third optical surface 925a, in which the level surface and the light-emitting surface 921c are on a same plane. The fourth optical surface 925b is inclined in relation to the second light-incident surface 921b to form a fourth angle β4. It is noted that, the fourth optical surface 925b extends from the bottom portion to the top portion of the second microstructure 925, and the fourth angle β4 is an included angle between the fourth optical surface 925b and a level surface passing through a bottom portion of the fourth optical surface 925b, in which the level surface and the light-emitting surface 921c are on a same plane. In the present embodiment, the smaller one of the third angle α4 and the fourth angle β4 faces towards the second light-incident surface 921b, and the greater one of the third angle α 4 and the fourth angle β4 faces away from the second light-incident surface 921b. In one embodiment, the fourth angle β4 is smaller that the third angle α4.

It is noted that, the first microstructures 923 and the second microstructures 925 shown in FIG. 15 and FIG. 16 are merely used as an example for explanation, and embodiments of the present invention are not limited thereto. In other embodiments, the first microstructures 923 and the second microstructures 925 may have different designs. In some examples, each of the first microstructures 923 and the second microstructures 925 can be a convex portion or a concave portion. In other examples, each of the first microstructures 923 and the second microstructures 925 can be structures similar to the aforementioned microstructures 200, 220, 300, 320, 400, 500 and 640.

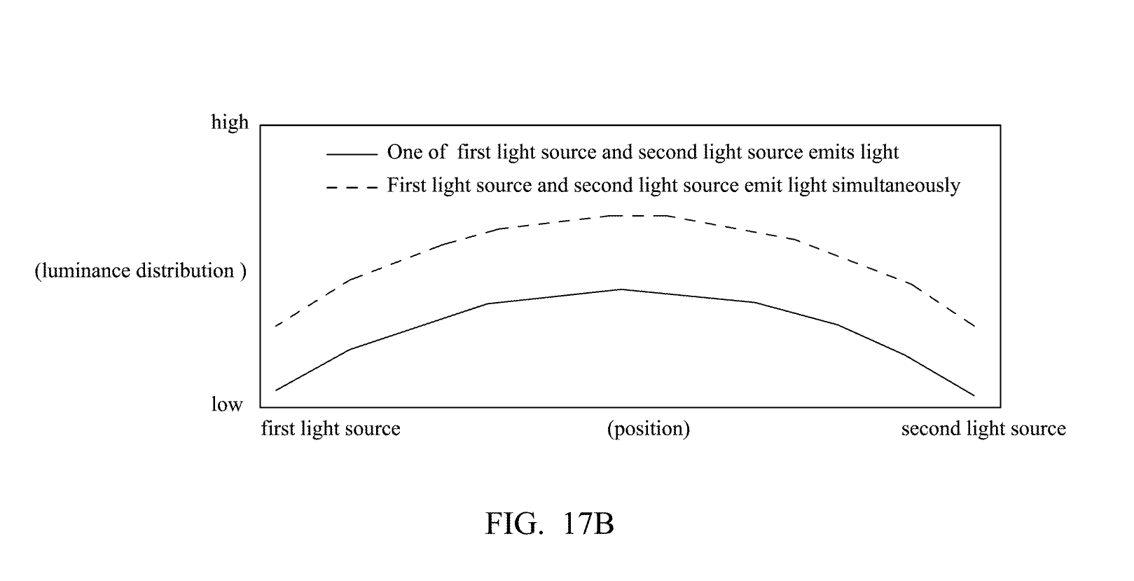

Referring to FIG. 15 and FIG. 17A, FIG. 17A is a schematic diagram showing arrangement densities of the first microstructures 923 and the second microstructures 925 respectively arranged in relation to the first light source 940 and the second light source 960. The first microstructures 923 and the second microstructures 925 are arranged on the light-emitting surface 921c. Moreover, there is a distance between two adjacent first microstructures 923, in which the distance is smaller with increase of a distance between the first microstructures 923 and the first light-incident surface 921a (corresponding to the first light source 940). In other words, the first microstructures 923 near the first light-incident surface 921a are sparsely arranged, and the first microstructures 923 away from the first light-incident surface 921a are densely arranged. Similarly, there is a distance between two adjacent second microstructures 925, in which the distance is smaller with increase of a distance between the second microstructures 925 and the second light-incident surface 921b (corresponding to the second light source 960). In other words, the second microstructures 925 near the second light-incident surface 921b are sparsely arranged, and the second microstructures 925 away from the second light-incident surface 921b are densely arranged.

Referring to FIG. 15 and FIG. 16 again, the first microstructures 923 are mainly used to change light-emitting angle and directivity of light emitted from the first light source 940. The second microstructures 925 are mainly used to change light-emitting angle and directivity of light emitted from the second light source 960. In addition, as shown in FIG. 15, because a variation direction of arranging density of the first microstructures 923 arranged in relation to the first light-incident surface 921a is opposite to that of the second microstructures 925 arranged in relation to the second light-incident surface 921b, the first microstructures 923 and the second microstructures 925 can be uniformly arranged on the main body 921. Therefore, when the first light source 940 and the second light source 960 emits light simultaneously, signally or alternately, light generated by the first light source 940 and the second light source 960 can be reflected and refracted by the light guide plate 920, so as to achieve the effect of better luminance uniformity.

Referring to FIG. 15 and FIG. 17B, FIG. 17B is a diagram showing luminance distribution on the light guide plate 920 when one or both of the first light source 940 and the second light source 960 emit light. The first microstructures 923 and the second microstructures 925 are distributed from sparsely to densely along a direction from one side of the light-emitting surface 921c to the other side of the light-emitting surface 921c. Therefore, as shown in FIG. 15, an arrangement density of microstructures in a middle area of the light guide plate 920 is smaller than that of microstructures in side areas adjacent to the first light-incident surface 921a and the second light-incident surface 921b, so as to achieve the effect of luminance distribution shown in FIG. 17B. In other embodiments, with different requirements of luminance distributions, arrangement densities of the first microstructures 923 and second microstructures 925 in the middle area can be adjusted to be higher than or equal to that of the first microstructures 923 and second microstructures 925 n the side areas. It is noted that the present embodiments should not be construed to limit the scope of the invention.

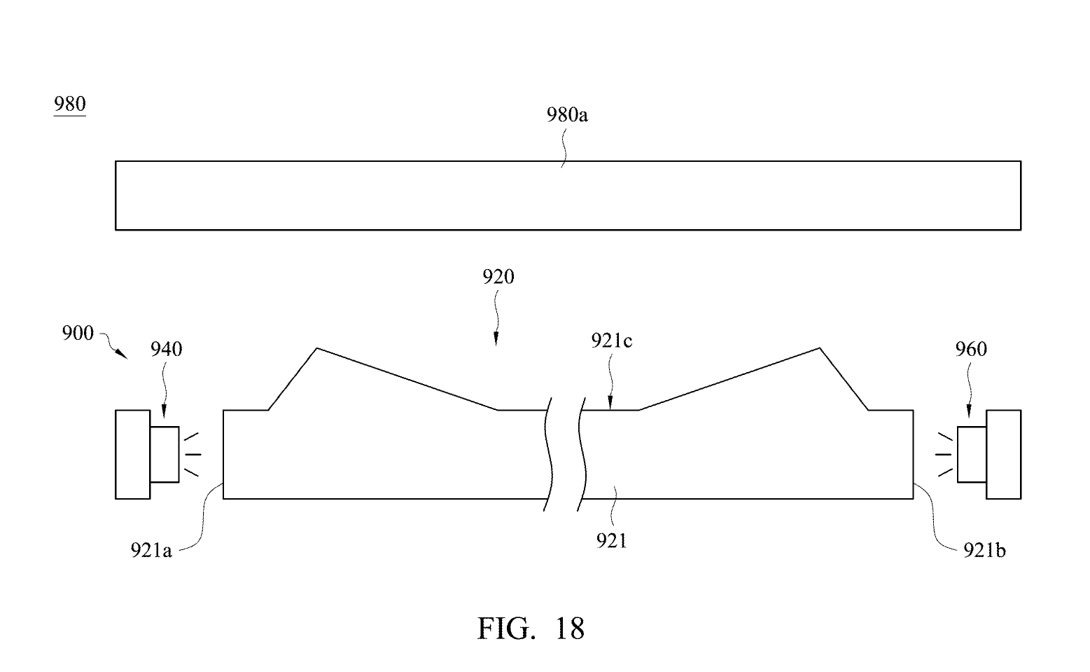

Referring to FIG. 18, FIG. 18 is a schematic structural diagram showing a display device 980 in accordance with an embodiment of the present invention. The display device 980 of the present embodiment includes a light source module 900 and a display panel 980a. As shown in FIG. 18, the display panel 980a is disposed above the light source module 900. After emitted from the light guide plate 920, light provided by the first light source 940 and the second light source 960 of the light source module 900 enters the display panel 980a, so as to achieve the aforementioned objects and will not be described again herein. It is noted that, by emitting light alternately through the first light source 940 and the second light source 960, the display device 980 can achieve 3D display effect.

According to the aforementioned embodiments of the present invention, the light-emitting angle and directivity of the light emitted from the light guide plate can be changed by varying shapes, angles, heights, depths or arrangements of the microstructures, so as to increase light-emitting efficiency and uniformity of the overall light-emitting appearance of the light guide plate. In addition, by collocating the light-mixing structures near the light-incident surface of the light guide plate and the microstructures, the problems of non-uniform appearance causing by the dark/bright bands near the light-incident surface of the conventional light guide plate can be improved, thus increasing the optical effect of the light guide plate.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light guide plate, comprising:
a main body comprising a first light-incident surface, a second light-incident surface and a light-emitting surface, wherein the light-emitting surface is connected to the first light-incident surface and the second light-incident surface; and
a plurality of first microstructures disposed on the light-emitting surface, wherein each of the first microstructures comprises:
a first optical surface which is inclined in relation to the first light-incident surface and is connected to the light-emitting surface, wherein a first angle is included between the first optical surface and the light-emitting surface; and
a second optical surface which is inclined in relation to the first light-incident surface and is connected to the light-emitting surface, wherein a second angle is included between the second optical surface and the light-emitting surface, wherein the smaller one of the first angle and the second angle faces towards the first light-incident surface, and the greater one of the first angle and the second angle faces away from the first light-incident surface;
a plurality of second microstructures disposed on the light-emitting surface, wherein each of the second microstructures comprises:
a third optical surface which is inclined in relation to the second light-incident surface and is connected to the light-emitting surface, wherein a third angle is included between the third optical surface and the light-emitting surface; and
a fourth optical surface which is inclined in relation to the second light-incident surface and is connected to the light-emitting surface, wherein a fourth angle is included between the fourth optical surface and the light-emitting surface, wherein the smaller one of the third angle and the fourth angle faces towards the second light-incident surface, and the greater one of the third angle and the fourth angle faces away from the second light-incident surface;
wherein a length, a width and a height of the first microstructures and the second structures are smaller than that of the main body.

2. The light guide plate of claim 1, wherein the first optical surface and the second optical surface of each of the first microstructures are connected to form a ridge line substantially parallel to an edge of the first light-incident surface.

3. The light guide plate of claim 1, wherein the third optical surface and the fourth optical surface of each of the second microstructures are connected to form a ridge line substantially parallel to an edge of the second light-incident surface.

4. The light guide plate of claim 1, wherein each of the first microstructures includes:
a first side optical surface connecting the light-emitting surface, the first optical surface and the second optical surface, wherein a first side angle is included between the first side optical surface and the light-emitting surface; and
a second side optical surface connecting the light-emitting surface, the first optical surface and the second optical surface, wherein a second side angle is included between the second side optical surface and the light-emitting surface.

5. The light guide plate of claim 4, wherein
each of the first microstructures further comprises a top surface connecting the first optical surface, the second optical surface, the first side optical surface and the second side optical surface, and an edge of the top surface connected to the first optical surface or the second optical surface is substantially parallel to an edge of the first light-incident surface; and
each of the top surfaces is a flat surface or an arc surface.

6. The light guide plate of claim 4, wherein each of the first side optical surfaces has one or more flat, angled, faceted or curved reflective or refractive surfaces to change a light output ray angle distribution to a greater extent.

7. The light guide plate of claim 4, wherein each of the second side optical surfaces has one or more flat, angled, faceted or curved reflective or refractive surfaces to change a light output ray angle distribution to a greater extent.

8. The light guide plate of claim 1, wherein each of the second microstructures includes:
a third side optical surface connecting the light-emitting surface, the third optical surface and the fourth optical surface, wherein a third side angle is included between the third side optical surface and the light-emitting surface; and
a fourth side optical surface connecting the light-emitting surface, the third optical surface and the fourth optical surface, wherein a fourth side angle is included between the fourth side optical surface and the light-emitting surface.

9. The light guide plate of claim 8,
wherein each of the second microstructures further comprises a top surface connecting the third optical surface, the fourth optical surface, the third side optical surface and the fourth side optical surface, and an edge of the top surface connected to the third optical surface or the fourth optical surface is substantially parallel to an edge of the second light-incident surface; and
each of the top surfaces is a flat surface or an arc surface.

10. The light guide plate of claim 8, wherein each of the third side optical surfaces has one or more flat, angled, faceted or curved reflective or refractive surfaces to change a light output ray angle distribution to a greater extent.

11. The light guide plate of claim 8, wherein each of the fourth side optical surfaces has one or more flat, angled, faceted or curved reflective or refractive surfaces to change a light output ray angle distribution to a greater extent.

12. The light guide plate of claim 1, wherein each of the first microstructures and second microstructures is a convex portion or a concave portion.

13. The light guide plate of claim 1, wherein the main body further comprises a surface opposite to the light-emitting surface, and a plurality of optical microstructures are disposed on the surface.

14. The light guide plate of claim 13, wherein the optical microstructures are dotted structures, striped structures, or structures similar to the first microstructures or second microstructures.

15. The light guide plate of claim 1, wherein there is a distance between two adjacent first microstructures, wherein the distance is smaller with increase of a distance between the first microstructures and the first light-incident surface.

16. The light guide plate of claim 1, wherein there is a distance between two adjacent second microstructures, wherein the distance is smaller with increase of a distance between the second microstructures and the second light-incident surface.

17. A light source module, comprising:
a light guide plate as claimed in claim 1;
a first light source disposed adjacent to the first light-incident surface of the light guide plate; and
a second light source disposed adjacent to the second light-incident surface of the light guide plate.

18. The light source module of claim 17, wherein the first light source and/or the second light source can emit light.

19. The light source module of claim 17, wherein the first light source and the second light source can alternately emit light.

20. A display device, comprising:
a light source module as claimed in claim 17, and
a display panel disposed above the light source module.
